(19) United States
(12) Patent Application Publication
(10) Pub. No.: US 2022/0071425 A1
(43) Pub. Date: Mar. 10, 2022

(54) ACTIVE MOTION ANTI-FATIGUE MAT

(71) Applicant: Joel Heath, Santa Barbara, CA (US)

(72) Inventor: Joel Heath, Santa Barbara, CA (US)

(21) Appl. No.: 17/525,070

(22) Filed: Nov. 12, 2021

(51) Int. Cl. A47G 27/02; B32B 3/26

(52) U.S. Cl. CPC A47G 27/0231; B32B 3/266; B32B 2307/744; B32B 2307/546; B32B 2471/04

(57) ABSTRACT

Provided is an active motion anti-fatigue mat that includes a platform and a base. The platform being positioned at the top of the base and is configured to flex in at least more than one direction in the plane orthogonal to the plane of the platform. The platform is configured to flex by virtue of a plurality of slits cut on the surface of the platform and the thickness of the platform.

### FIELD OF INVENTION

The present invention generally relates to a house-hold and office accessory for providing comfort to the user while executing various house-hold and work tasks. More particularly, the present invention relates to an active motion anti-fatigue mat made up of predominantly natural materials.

### BACKGROUND

There are certain work tasks that require a standing posture such as ironing clothes, washing clothes, washing utensils in the kitchen and working at a standing desk or counter etc. However, being in a prolonged standing posture waiting for the tasks to be done has its own challenges. One may get easily fatigued and could have health/foot/leg impairments due to such long standing postures.

Considering such health-related issues that are borne from doing work tasks continuously, various accessories are in trend to provide comfort to the user. One such accessory includes active motion anti-fatigue mats. The conventional active motion anti-fatigue mats are not adapted for long use in terms of standing/sitting for longer durations. Also, these mats restrict a user to use the mats in stationary positions for prolonged periods. Most importantly, the conventional active motion anti-fatigue mats are manufactured by non-biodegradable material including petroleum-based plastics or other polymers. These petroleum-based plastics are not suitable to be used in the floor mats as they provide continuous odor, which may be spread in the interiors of an individual's house. Further, the odor mixed air would be un-favorable, thus restricting the use of the mats in the kitchens. The conventional petroleum-based mats require a critical or complex manufacturing method that adds on to the cost and further these mats are not able to be recycled therefore, only way for disposing them is to throw away in the landfills, which pollutes the environment.

In the light of foregoing, there is a need of an active motion anti-fatigue mat that can be manufactured from natural materials and thus mitigating the pollution in the environment. Furthermore, there is a need to manufacture such mats using relatively simple method and consequently controlling the costs associated with the manufacturing of such mats. Thus, an active motion anti-fatigue mat to address the aforementioned problems is desired.

### BRIEF SUMMARY

Before the present systems and methods, embodiments are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

It is an object of the present invention to provide an active motion anti-fatigue mat including a platform and a base. The platform being positioned at the top of the base and is configured to flex in at least more than one direction in the plane orthogonal to the plane of the platform. The platform is configured to flex by virtue of a plurality of slits cut on the surface of the platform.

In an embodiment, the base further comprising a slip resistant layer provided below the frame to prevent slippage of the active motion anti-fatigue mat when placed on a surface.

In an embodiment, the frame is configured with a plurality of recessed portions providing a play or gap between the platform and the surface on which the active motion anti-fatigue mat is placed.

In an embodiment, the platform and the base of the active motion anti-fatigue mat are manufactured from plywood, natural wool felt blend, natural rubber or any combination thereof.

In an embodiment, the plurality of slits cut on the surface of the platform is provided by performing pattern cutting on the surface of the platform.

In an embodiment, the arrangement of the slits provided on the surface of the platform allows variation in degree of flex of the platform on application of load on the platform of the active motion anti-fatigue mat. Further, the thickness of the platform could be varied to allow variation in degree of flex of the platform.

In an embodiment of the present invention, a balance-board placed on the top of the platform. The balance board includes a balancing base having a bulged profile at the center and thin profile at either ends of the balancing base.

In an embodiment, the balancing base exhibits a bulged profile at the center and a thin profile at either ends of the balancing base.

In another embodiment of the present invention, the active motion anti-fatigue mat includes a platform exhibiting a patch of acupressure and a base.

In an embodiment, the platform of the active motion anti-fatigue mat includes a plurality of side protrusions projecting from the periphery of the platform, wherein the side protrusions are configured to receive foot or any other body portion of the user.

Various objects, features, aspects and advantages of the present invention will become more apparent from the following detailed description of the embodiments of the invention, along with the accompanying drawings in which like numerals represent like components.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 illustrates an exploded view of an active motion anti-fatigue mat, according to an embodiment of the present invention;

FIG. 2A illustrates an isometric view of the active motion anti-fatigue mat, according to an embodiment of the present invention;

FIG. 2B illustrates an isometric front view of a base of the active motion anti-fatigue mat, according to an embodiment of the present invention;

FIG. 2C illustrates an isometric rear view of the active motion anti-fatigue mat, according to an embodiment of the present invention;

FIG. 3 illustrates an isometric view of an operative state of the active motion anti-fatigue mat, according to an embodiment of the present invention;

FIG. 4 illustrates a front view of a balance board placed on top of the active motion anti-fatigue mat and being used by a user, according to an embodiment of the present invention; and

FIG. 5 illustrates different arrangements/orientations of the slits on the platform of the active motion anti-fatigue mat, according to an embodiment of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

The term “active motion anti-fatigue mat” used herein the description means that the mat is capable to flex actively whenever there is load application by a user during use. Further, the active motion inherited in the mat allows fatigueless usage of the mat by the user. Broadly speaking, the term “active motion anti-fatigue mat” includes any mat or similar structure that provides active movement of the user while using the “active motion anti-fatigue mat”.

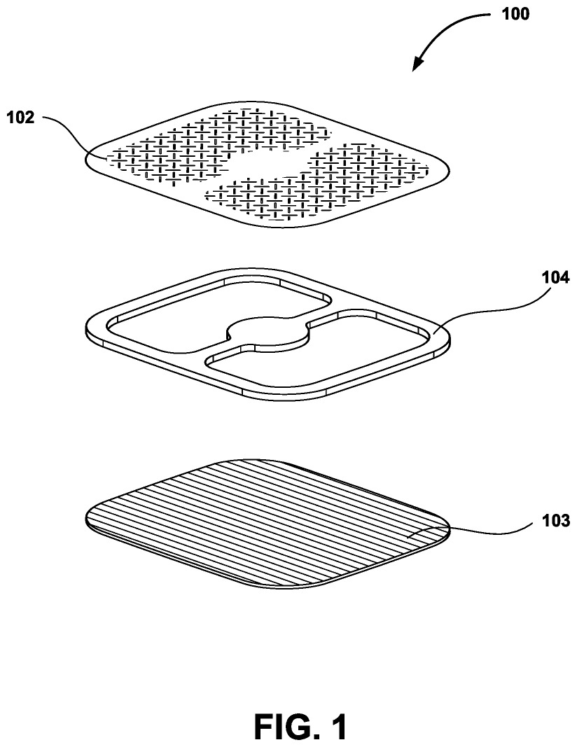

The various features and embodiments of an active motion anti-fatigue mat of the present invention will now be described in conjunction with the accompanying figures, namely FIGS. 1-5.

FIG. 1 depicts an exploded view of an active motion anti-fatigue mat 100. The Active motion anti-fatigue mat 100 includes a platform 102, a slip resistant layer 103 and a base 104.

The platform 102 is positioned on the top of the base 104 and the slip-resistant layer 103 is bonded to the bottom side of the base 104 by an adhesive. Alternatively, in another embodiment, the slip-resistant layer 103 is integrally connected/removably connected to the bottom side of the base 104 by other known techniques such as but not limited to: sewing, knitting, rivets, pins and so on. The bottom side of the base 104 being the side adjoining the surface on which the active motion anti-fatigue mat 100 is placed.

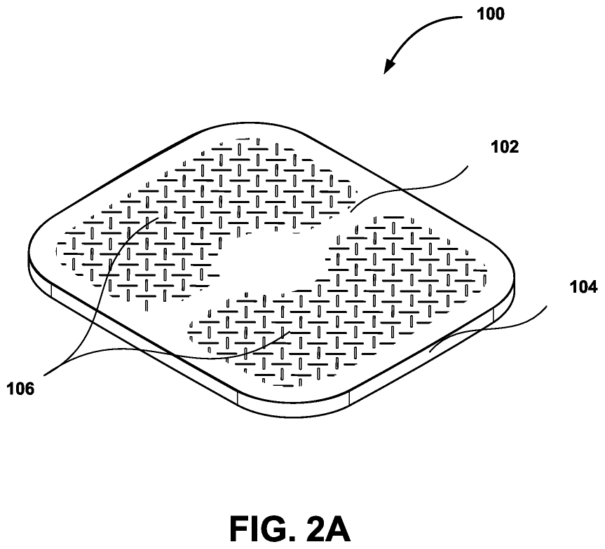

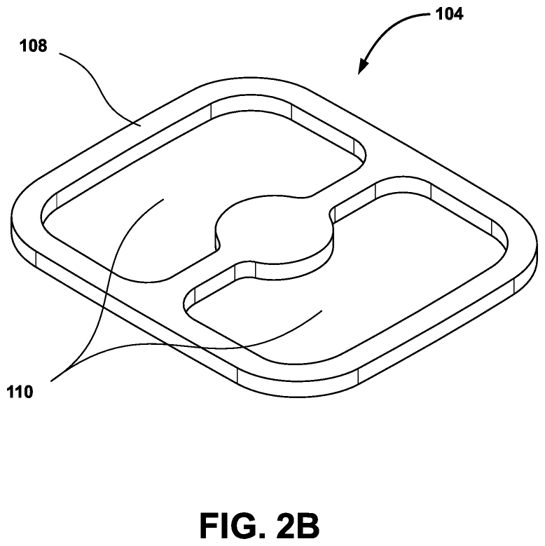

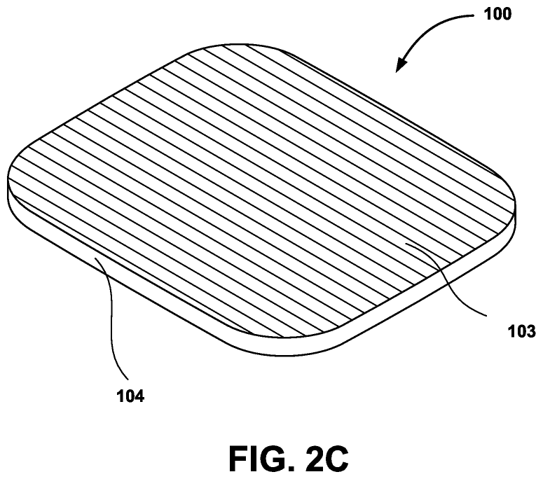

Referring to FIG. 2A and FIG. 2B depicting isometric views of the active motion anti-fatigue mat 100 and the base 104 respectively. The platform 102 further includes a number of slits/slots/cuts (hereinafter referred to as slits) 106. The slits 106 are provided or cut on the surface of the platform 102. The base 104 further include a frame 108.

Referring to FIG. 2C depicting an isometric rear view of the active motion anti-fatigue mat 100. FIG. 2C depicts the active motion anti-fatigue mat 100 of FIG. 2A in the inverted state. As can be clearly seen from the figure, the slip-resistant layer 103 is bonded to the bottom side of the base 104. The slip resistant layer 103 helps preventing slippage of the active motion anti-fatigue mat 100 when used by a user 302.

In an embodiment (not shown in figures), the slip-resistant layer 103 corresponds to the same shape as that of the base 104. In other words, the shape of the slip-resistant layer 103 is substantially similar to the base 104 and the slip resistant layer 103 helps preventing slippage of the active motion anti-fatigue mat 100 when used by a user 302.

The frame 108 further includes at least one recessed portion 110. In an embodiment, the recessed portion 110 of same size can be provided at one or more than one locations of the frame 108. In an embodiment, the recessed portion 110 of different sizes can be provided at one or more than locations of the frame 108. In an embodiment, the frame 108 can include a number of layers positioned one on the top of the other and thus forming a substantial thickness of the frame 108 as compared to the thickness of the platform 102. The number of layers of the frame 108 provides a cushioning effect in the active motion anti-fatigue mat 100.

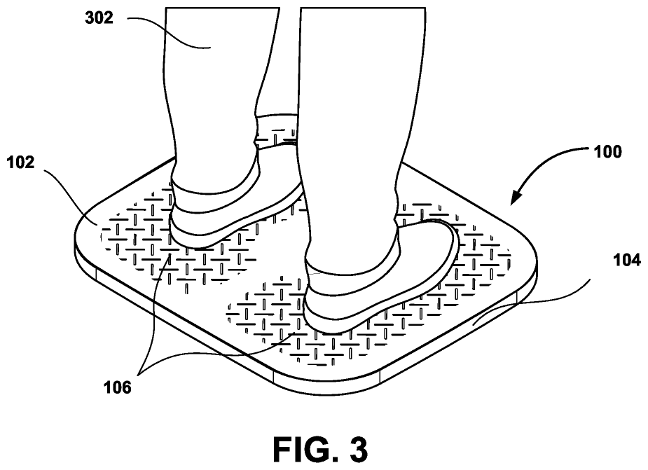

FIG. 3 illustrates an isometric view of the operative state of the active motion anti-fatigue mat 100. The operative state of the active motion anti-fatigue mat 100 being the state where the active motion anti-fatigue mat 100 is used by a user 302. In FIG. 3, the user 302 is shown standing on the platform 102 of the active motion anti-fatigue mat 100 for executing certain work tasks.

The slits 106 of the platform 102 provide necessary flexibility to the platform 102, which adds to provide a dynamic active motion effect to the active motion anti-fatigue mat 100. This effect created by virtue of the slits 106 enables the user 302 standing on the active motion anti-fatigue mat 100 to exhibit natural movement and relief along-with spring like performance while executing work tasks such as in kitchen, standing by the work-desk or the like. Further, the slits 106 play a vital role in ensuring a minimal flex to the user 302 while he/she is using the active motion anti-fatigue mat 100 in a particular stance during execution of household tasks.

The recessed portion 110 facilitates a play or gap between the platform 102 and the floor surface or any other surface on which the active motion anti-fatigue mat 100 is placed. This play or gap provided by the recessed portion 110 ensures depressing or easy flexing of the platform 102, when the user 302 stands on the platform 102 while performing tasks. The play therefore, ensures an adequate space provided to the platform 102 to flex and therefore avoids any premature failure of the active motion anti-fatigue mat 100. The slip resistant layer 103 is configured to enhance friction between the base 104 and the surface on which the active motion anti-fatigue mat 100 is placed and thereby preventing slippage of the active motion anti-fatigue mat 100, when used by the user 302.

In an embodiment, the platform 102 is manufactured from a ply-wood. In an embodiment, the plywood is a 5-layer ply with a water-based sealant.

In an embodiment, the slits 106 can be cut by performing laser cutting or using CNC machines on the surface of the platform 102.

In an embodiment, the slits 106 can be featured on the surface of the platform 102 by any other suitable cutting process.

In an embodiment, the dimensions such as length or width of the slits 106 can be varied in order to meet various flexibility requirements of the active motion anti-fatigue mat 100.

In an embodiment, shape, layout or design of the pattern/arrangement of the slits 106 on the platform 102 can be varied in order to change degree of flexing of the platform 102 to meet various weight bearing capacities and other mechanical-design requirements of the active motion anti-fatigue mat 100 to enhance the performance of the active motion anti-fatigue mat 100.

In an embodiment, the frame 108 is manufactured from natural wool felt blend with a rubber finish, foam, wood, plastic or the combination thereof. In an embodiment, the thickness of the frame is 1″ (one inch). The actual size of the frame 108 and/or of the present invention is not considered a limiting embodiment of the present invention. Thus, the thickness of the frame can be of any value that is suitable for the active motion anti-fatigue mat 100.

In an embodiment, the platform 102 and/or the base 104 of the active motion anti-fatigue mat 100 is manufactured from Baltic birch, wood, natural wool blend felt, recycled rubber or the combination thereof.

In an embodiment, the slip resistant layer 103 is manufactured from a slip resistant material including but not limited to: natural wool felt blend, recycled rubber or the combination thereof.

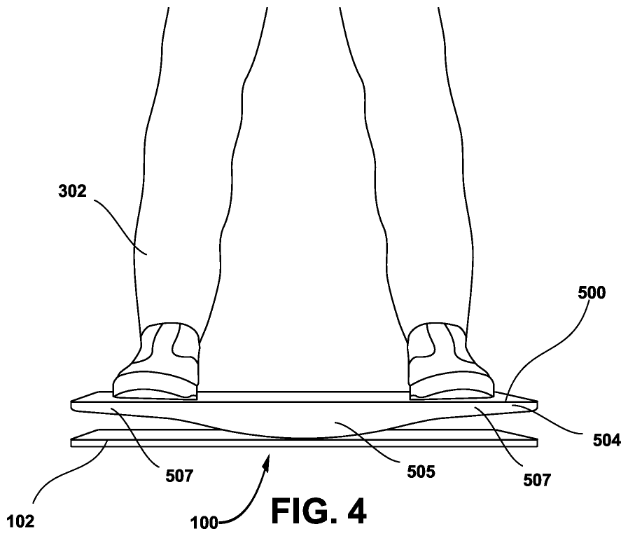

According to another embodiment of the present disclosure as shown in FIG. 4 a balance-board 500 is shown used by a user 302 on top of the active motion anti-fatigue mat 100. As seen, the platform 102 of the active motion anti-fatigue mat 100 is placed below a balancing base 504 of the balance board 500. The platform 102 is configured to flex upon application of load by virtue of plurality of slits 106 provided on the surface of the platform 102. The frame 108 (FIG. 1) of the base 104 (FIG. 1) provides a cushioning effect in the active motion anti-fatigue mat 100 and/or frame 108 further supports the load exerted by the user 302. The slip resistant layer 103 (FIG. 1) is configured to enhance friction between the base 104 and the surface on which the active motion anti-fatigue mat 100 is placed and thereby preventing slippage of the active motion anti-fatigue mat 100, when used by the user 302. The balancing base 504 exhibits a bulged profile 505 at the center and a thin profile 507 at either ends of the balancing base 504 as can be clearly seen in FIG. 4. The bulged profile 505 of the balancing base 504 is an arcuate profile that allows rolling/pitching/tilting of the balance-board 500, when used by the user 302 and hence providing customary requirements to the user 302.

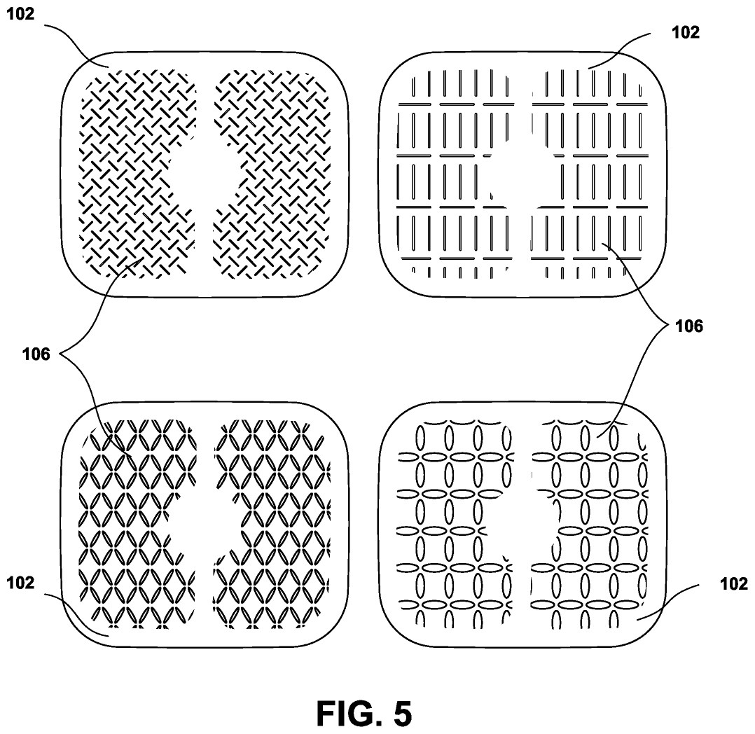

Referring to FIG. 5 illustrating different arrangements/orientations of the slits 106 on the platform 102 of the active motion anti-fatigue mat 100 is provided. The different arrangements of the slits 106 enable different degrees of flexure to be exhibited by the platform 102 of the active motion anti-fatigue mat 100. The different arrangements of the slits 106 can be selected based on the load bearing capacity of the platform 102 of the active motion anti-fatigue mat 100, thereby the different arrangements of the slits 106 on the platform 102 allows the usage of the active motion anti-fatigue mat 100 in variety of applications. The amount of load or load bearing capacity can be a factor of application of the active motion anti-fatigue mat 100, for instance, when the active motion anti-fatigue mat 100 is used by kids to hop on, the load bearing capacity can be decreased and when the active motion anti-fatigue mat 100 is used by adults for executing tasks with more weight, the load bearing capacity can be increased accordingly.

In yet another embodiment of the present invention as shown in FIGS. 1-3, the active motion anti-fatigue mat 100 is disclosed. The active motion anti-fatigue mat 100 is configured to mitigate the fatigue experienced by a user that is caused by prolonged standing or sitting postures while executing household tasks. The platform 102 of the active motion anti-fatigue mat 100 exhibits an acupressure feature (not shown). The acupressure feature can be provided at the center of the platform 102 provides relaxation to the user and helps in maintaining optimum blood-pressure while using the active motion anti-fatigue mat 100 and hence relieving fatigue of the user. The platform 102 further includes a number of slits/slots (hereinafter referred to as slits) 106. The slits 106 are provided or cut on the surface of the platform 102. The base 104 further include a frame 108. The frame 108 further includes a recessed portion 110. In an embodiment, the frame 108 can include a number of layers positioned one on the top of the other and thus forming a substantial thickness of the frame 108 as compared to the thickness of the platform 102. The number of layers of the frame 108 provides a cushioning effect in the active motion anti-fatigue mat 100. The slits 106 of the platform 102 provide necessary flexibility to the platform 102, which adds on to provide a dynamic effect to the active motion anti-fatigue mat 100. This effect created by virtue of the slits 106 enables the user 302 standing on the active motion anti-fatigue mat 100 to exhibit natural movement and relief along-with spring like performance while executing household tasks such as in kitchen, standing by the work-desk or the like. Further, the slits 106 play a vital role in ensuring a minimal bounce back force to the user 302 while he/she using the active motion anti-fatigue mat 100 in a particular stance during execution of household tasks.

In an embodiment, the platform 102 of the active motion anti-fatigue mat 100 exhibits side protrusions or bulged portion (not shown) at the periphery of the platform 102. The side protrusions extend upwardly from the platform 102 up to a certain length that enables the user to allow keeping his/her feet for providing comfort, while using the active motion anti-fatigue mat 100.

The various components, parts of the various embodiments of the active motion anti-fatigue mat 100 of the present invention are similar and interchangeable. It is obvious to the one skilled in the art that the various components, parts of the active motion anti-fatigue mat 100 of one embodiment of the present invention could be considered for other embodiments with little or no variation.

It should be understood that active motion anti-fatigue mat 100 of the present invention could be used in various scenarios/places. For instance, the active motion anti-fatigue mat 100 could be used by a user while a user is using a standing desk and performing his/her routine tasks. The user can place his/her feet on the active motion anti-fatigue mat 100 while standing adjacent to a standing desk. Further, it should be obvious to the one skilled in the art that the active motion anti-fatigue mat 100 could be used in various other scenarios/places such as but not limited to: exhibition counters, gyms, sitting chairs, offices, work stations, waiting lines, lecture podiums, physiotherapy sessions and so on.

It should be understood that flexibility of the active motion anti-fatigue mat 100 is variable. Depending on the user requirement, the pattern of the platform 102, the arrangement/number of the slits 106 provided on the surface of the platform 102 and the thickness of the platform 102 could be varied during manufacturing process to allow variation in degree of flex of the platform and/or active motion anti-fatigue mat 100. Thus, the active motion anti-fatigue mat 100 is customizable to allow the usage of active motion anti-fatigue mat 100 in various scenarios depending on the user requirement.

It should be understood according to the preceding description of the present invention that the same is susceptible to changes, modifications and adaptations, and that the said changes, modifications and adaptations fall within scope of the appended claims.

What is claimed is:

1. An active motion anti-fatigue mat (100) comprising:
a platform (102) and a base (104);
the platform (102) comprises a plurality of slits (106) cut in a pattern on the surface of the platform (102);
wherein the platform (102) being positioned at the top of the base (104) and configured to flex in at least more than one direction in the plane orthogonal to the plane of the platform (102); and wherein the platform (102) is configured to flex by virtue of the plurality of slits (106) cut on the surface of the platform (102) and the thickness of the platform (102).

2. The active motion anti-fatigue mat (100) as claimed in claim 1, wherein the base (104) further comprising a slip resistant layer (103) to prevent slippage of the active motion anti-fatigue mat (100) when placed on a surface.

3. The active motion anti-fatigue mat (100) as claimed in claim 1, wherein the base (104) further comprising a frame (108) includes a plurality of recessed portions (110) providing a play or gap between the platform (102) and the surface on which the active motion anti-fatigue mat (100) is placed.

4. The active motion anti-fatigue mat (100) as claimed in claim 1, wherein the platform (102) and/or the base (104) of the active motion anti-fatigue mat (100) are manufactured from natural wool felt blend, recycled rubber or any combination thereof.

5. The active motion anti-fatigue mat (100) as claimed in claim 1, wherein the plurality of slits (106) cut on the surface of the platform (102) are provided by performing laser cutting on the surface of the platform (102).

6. The active motion anti-fatigue mat (100) as claimed in claim 1, wherein the arrangement of the slits (106) provided on the surface of the platform (102) allows variation in degree of flex of the platform (102) on application of load on the platform (102) of the active motion anti-fatigue mat (100).

7. The active motion anti-fatigue mat (100) as claimed in claim 1, wherein the platform (102) comprises a patch of acupressure.

8. The active motion anti-fatigue mat (100) as claimed in claim 1, wherein the platform (102) further comprising a plurality of side protrusions projecting from the periphery of the platform (102), wherein the side protrusions are configured to receive foot or any other body portion of the user.

9. The active motion anti-fatigue mat (100) as claimed in claim 1, wherein the active motion anti-fatigue mat (100) is usable with a balance-board (500) comprising a balancing base (504) positioned above the platform (102) of the active motion anti-fatigue mat (100).

10. The active motion anti-fatigue mat (100) as claimed in claim 9, wherein the balancing base (504) exhibits a bulged profile (505) at the center and a thin profile (507) at either ends of the balancing base (504).

11. An active motion anti-fatigue mat (100) as claimed in claim 1, wherein the flexibility of the active motion anti-fatigue mat (100) is variable.

12. An active motion anti-fatigue mat (100) as claimed in claim 12, wherein the flexibility of the active motion anti-fatigue mat (100) is varied by changing thickness of the platform (102), pattern of the platform (102), the arrangement/number of the slits (106) provided on the surface of the platform (102).
